(19) United States
(12) Patent Application Publication
(10) Pub. No.: US 2022/0167171 A1
(43) Pub. Date: May 26, 2022

(54) SECURITY ANOMALY DETECTION FOR INTERNET OF THINGS DEVICES

(71) Applicants: AT&T Intellectual Property I, L.P., Atlanta, GA (US); AT&T Mobility II LLC, Atlanta, GA (US)

(72) Inventors: Mike Iapalucci, Carrollton, TX (US); Jeff Bartlett, Dallas, TX (US); Jordan Alexander, Kennesaw, GA (US)

(21) Appl. No.: 17/100,783

(22) Filed: Nov. 20, 2020

(51) Int. Cl. H04W 12/12; G16Y 40/50; G16Y 30/10; H04L 12/26; G06F 8/65

(52) U.S. Cl. CPC H04W 12/1204; G16Y 40/50; G06F 8/65; H04L 43/0888; H04L 43/16; G16Y 30/10

(57) ABSTRACT

An example method includes collecting historical control plane data associated with an internet of things device connected to a radio access network, constructing a baseline behavioral model for the internet of things device, based on the historical control plane data, monitoring control plane data currently associated with the internet of things device, detecting an anomaly in the control plane data currently associated with the internet of things device, based on the baseline behavioral model for the internet of things device, and initiating a remedial action in response to the detecting.

The present disclosure relates generally to network security, and relates more particularly to devices, non-transitory computer-readable media, and methods for detecting security anomalies in Internet of Things devices connected to a radio access network.

### BACKGROUND

Internet of Things (IoT) devices include devices that are embedded with sensors, software, and/or other technologies for the purpose of connecting and exchanging data with other devices and systems over the Internet. Thus, IoT devices may provide a great convenience by simplifying and automating many previously manual tasks. For instance, IoT devices used in home automation might include an Internet-connected doorbell that transmits video of a home's front door to the homeowner's mobile phone, or an Internet-connected thermostat that allows a homeowner to control the temperature of his home from his mobile phone. IoT devices used in manufacturing might include Internet-connected control systems that automate process controls, operator tools, and service information systems to optimize safety and security in a manufacturing facility. IoT devices used in connected vehicles might be implemented to perform manufacturer and/or consumer functions. For instance, a connected vehicle could, itself, be considered an IoT device if the connected vehicle has mobile broadband connectivity through its telecommunications control unit (TCU)/head unit. A consumer function implemented in a connected vehicle might include an Internet-connected audio system that can be controlled by a driver's (or a passenger's) mobile phone, or an Internet-connected application that can locate parking spots.

### SUMMARY

In one example, a method performed by a processing system includes collecting historical control plane data associated with an internet of things device connected to a radio access network, constructing a baseline behavioral model for the internet of things device, based on the historical control plane data, monitoring control plane data currently associated with the internet of things device, detecting an anomaly in the control plane data currently associated with the internet of things device, based on the baseline behavioral model for the internet of things device, and initiating a remedial action in response to the detecting.

In another example, a non-transitory computer-readable medium may store instructions which, when executed by a processing system in a communications network, cause the processing system to perform operations. The operations may include collecting historical control plane data associated with an internet of things device connected to a radio access network, constructing a baseline behavioral model for the internet of things device, based on the historical control plane data, monitoring control plane data currently associated with the internet of things device, detecting an anomaly in the control plane data currently associated with the internet of things device, based on the baseline behavioral model for the internet of things device, and initiating a remedial action in response to the detecting.

In another example, a device may include a processing system including at least one processor and non-transitory computer-readable medium storing instructions which, when executed by the processing system when deployed in a communications network, cause the processing system to perform operations. The operations may include collecting historical control plane data associated with an internet of things device connected to a radio access network, constructing a baseline behavioral model for the internet of things device, based on the historical control plane data, monitoring control plane data currently associated with the internet of things device, detecting an anomaly in the control plane data currently associated with the internet of things device, based on the baseline behavioral model for the internet of things device, and initiating a remedial action in response to the detecting.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for detecting security anomalies in Internet of Things devices connected to a radio access network may operate;

FIG. 2 illustrates a flowchart of an example method for detecting security anomalies in Internet of Things devices connected to a radio access network, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for detecting security anomalies in Internet of Things devices connected to a radio access network. As discussed above, Internet of Things (IoT) devices include devices that are embedded with sensors, software, and/or other technologies for the purpose of connecting and exchanging data with other devices and systems over the Internet. Thus, IoT devices may provide a great convenience by simplifying and automating many previously manual tasks. However, with this greater convenience also comes a greater risk for compromise. As more and more user data (and more and more sensitive user data in particular) is shared with IoT devices, the IoT devices become more attractive targets for individuals who may want to gain access to that user data. For instance, a remote individual may gain unauthorized access to a user's Internet-connected home security system, and may use that access to disable the home security system, to gather information about the user and his family, or to gain access to other systems and devices connected to the home security system.

Often, the compromise of an IoT device may not even be detected until it is too late. One way in which compromise of an IoT device may be detected is by detecting anomalies in the network traffic (e.g., Internet Protocol or IP packets) traversing the IoT device. For instance, a network operator may forward network traffic to a third party service provider for anomaly detection. However, the IP packets traversing an IoT device may be encrypted, particularly if the data contained in the packet payloads is considered sensitive. For instance, for privacy reasons, a user who has a smart doorbell installed in his home may not wish for others to see video images of his front door. Even if the IP packets are not encrypted, the user still may not wish for the data contained in the packets to be accessible to others.

Examples of the present disclosure detect anomalous behavior in cellular network connected IoT devices based on collection and analysis of the IoT devices' signaling (i.e., control plane) data. More specifically, examples of the present disclosure may construct a baseline of an IoT device's signaling behavior based on (third, fourth, fifth, and/or further generation) radio access network (RAN) control plane data that traverses the IoT device. Deviations from the baseline signaling behavior may indicate possible compromise of the IoT device. For instance, if the IoT device begins to generate an amount of outbound traffic that exceeds a baseline amount of outbound traffic for the IoT device by more than a threshold, or if a frequency of the outbound traffic generated by the IoT device exceeds a baseline frequency for the IoT device by more than a threshold, this may indicate that the IoT device has been compromised. Similarly, changes in the behavior of the inbound traffic to the IoT device may indicate that the IoT device has been compromised. Thus, a possible compromise of an IoT device may be detected based on network traffic traversing the IoT device, without the need to access the payloads of that network traffic (which may be encrypted or simply not accessible). Moreover, because of the network service provider's unique visibility into the control plane data, the network service provider may be able to perform anomaly detection without having to forward any data to a third party service provider for analysis.

Cellular connected devices in general, and IoT devices in particular, operation in a “connect data path and resources when needed” manner. This mode of operation preserves device battery life and facilitates sharing of limited network resources among a large number of devices. A cellular connected device may “listen” for incoming traffic (also known as “mobile terminated” traffic, or traffic for which the device is the destination) either all of the time, or periodically (e.g., at device- or situation-dependent intervals). A cellular connected device may also be “awakened” to listen for incoming traffic, for instance by sending a short message service (SMS) message to the device to alert the device to the fact that an incoming mobile terminated message is pending.

When a cellular connected device awakens, the device requests RAN resources and may send outgoing traffic (also known as “mobile originated” traffic, or traffic for which the device is the source) periodically (e.g., at a unique interval that suits the device's use case). For instance, an electromechanical fatigue crack sensor may report a reading once per day or whenever movement is detected in the sensor's zone of detection, while a water flow meter may report readings once per minute. RAN resources are released once the cellular connected device's (mobile originated or mobile terminated) transmission needs have been met (i.e., when there is no more data to be sent or received by the device).

Thus, RAN control plane data contains the RAN activities of potentially millions of cellular connected devices (including cellular connected IoT devices) that share the network and request RAN resources from the network for sharing and data transmission activities. The RAN control plane data may include IoT devices that are roaming (e.g., IoT devices including subscriber identity modules (SIMs) from network operators other than the operator of the RAN.

Within the context of the present disclosure, the “control plane” is understood to refer to the layer of a network (e.g., a radio access network) that is used for universal mobile telecommunications service (UMTS)-specific control signaling. “Control plane data” associated with a data packet traversing the network might therefore include call control (CC) and/or mobility management (MM) signaling messages associated with the data packet. By contrast, the “user plane” is understood to refer to the layer of the network that carries user information (e.g., data streams comprising pluralities of data packets). “User plane data” associated with a data packet traversing the network might therefore include the payload and/or headers of the data packet.

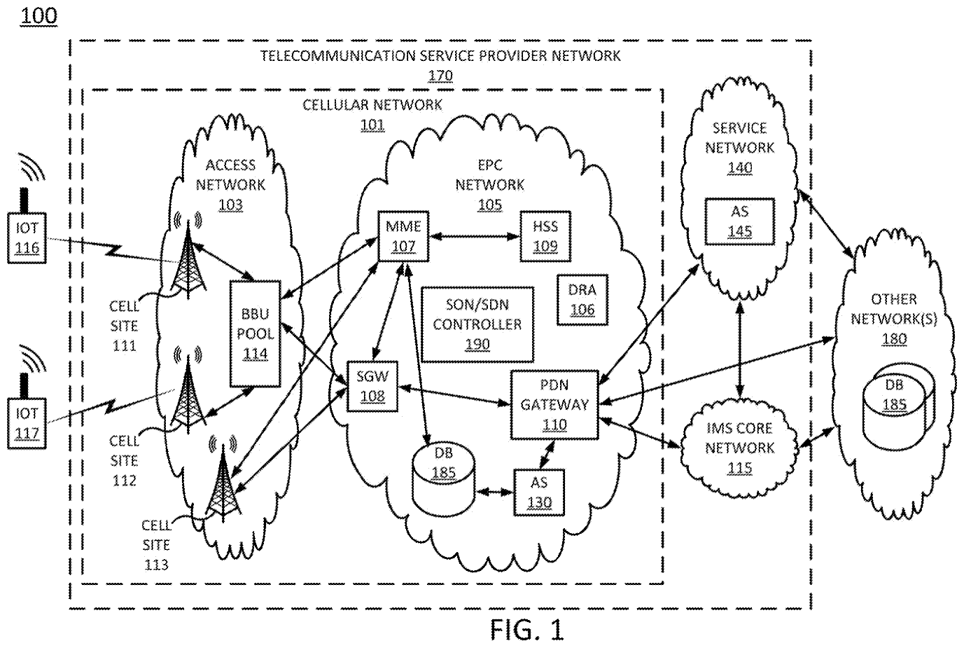

To better understand the present disclosure, FIG. 1 illustrates an example network, or system 100, in which examples of the present disclosure for detecting security anomalies in Internet of Things devices connected to a radio access network may operate. In one example, the system 100 includes a telecommunication service provider network 170. The telecommunication service provider network 170 may comprise a cellular network 101 (e.g., a 3^{rd} Generation (3G) network, a 4^{th} Generation (4G)/Long Term Evolution (LTE) network, a 4G/5^{th} Generation (5G) hybrid network, a 5G network, a subsequent generation network, or the like), a service network 140, and a core network, e.g., an IP Multimedia Subsystem (IMS) core network 115. The system 100 may further include other networks 180 connected to the telecommunication service provider network 105.

FIG. 1 also illustrates various Internet of Things (IoT) devices 116 and 117. IoT devices 116 and 117 may each comprise a device that is embedded with sensors, software, and/or other technologies for the purpose of connecting and exchanging data with other devices and systems over the Internet. For instance, the IoT devices 116 and 117 may include home automation devices (e.g., an Internet-connected doorbell system, lighting system, audio system, security system, thermostat, virtual assistant device, image capturing system, or the like), connected cars (e.g., including systems to control car audio systems, locate parking spots, and the like), industrial sensors (e.g., Internet-connected control systems that automate process controls, operator tools, and service information systems to optimize safety and security in a manufacturing facility), sensors for asset tracking, and/or other types of cellular-capable mobile telephony and computing devices that are embedded with sensors and software for connecting to and exchanging data over the Internet. The IoT devices 116 and 117 may be associated with a subscription service provided over the telecommunication service provider network 170, such as cellular phones services or other services.

In one example, the cellular network 101 may comprise an access network 103 and a core network, Evolved Packet Core (EPC) network 105. In one example, the access network 103 comprises a cloud RAN. For instance, a cloud RAN is part of the 3^{rd} Generation Partnership Project (3GPP) 5G specifications for mobile networks. As part of the migration of cellular networks towards 5G, a cloud RAN may be coupled to an EPC network until new cellular core networks are deployed in accordance with 5G specifications. In one example, access network 103 may include cell sites 111 and 112 and a baseband unit (BBU) pool 114. In a cloud RAN, radio frequency (RF) components, referred to as remote radio heads (RRHs), may be deployed remotely from baseband units, e.g., atop cell site masts, buildings, and so forth. In one example, the BBU pool 114 may be located at distances as far as 20-80 kilometers or more away from the antennas/remote radio heads of cell sites 111 and 112 that are serviced by the BBU pool 114. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site, may, in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 113 may include RRH and BBU components. Thus, cell site 113 may comprise a self-contained “base station.” With regard to cell sites 111 and 112, the “base stations” may comprise RRHs at cell sites 111 and 112 coupled with respective baseband units of BBU pool 114.

In one example, the EPC network 105 provides various functions that support wireless services in the LTE environment. In one example, EPC network 105 is an Internet Protocol (IP) packet core network that supports both real-time and non-real-time service delivery across a LTE network, e.g., as specified by the 3GPP standards. In one example, all cell sites in the access network 103 are in communication with the EPC network 105 via baseband units in BBU pool 114. In operation, IoT device 116 may access wireless services via the cell site 111 and IoT device 117 may access wireless services via the cell site 112 located in the access network 103. It should be noted that any number of cell sites can be deployed in access network. In one illustrative example, the access network 103 may comprise one or more cell sites.

In EPC network 105, network devices such as Mobility Management Entity (MME) 107 and Serving Gateway (SGW) 108 support various functions as part of the cellular network 101. For example, MME 107 is the control node for the LTE access network. In one embodiment, MME 107 is responsible for UE (User Equipment) tracking and paging (e.g., such as retransmissions), bearer activation and deactivation process, selection of the SGW, and authentication of a user. In one embodiment, SGW 108 routes and forwards user data packets, while also acting as the mobility anchor for the user plane during inter-cell handovers and as the anchor for mobility between LTE and other wireless technologies, such as 2G and 3G wireless networks.

In addition, EPC network 105 may comprise a Home Subscriber Server (HSS) 109 that contains subscription-related information (e.g., subscriber profiles), performs authentication and authorization of a wireless service user, and provides information about the subscriber's location. The EPC network 105 may also comprise a packet data network (PDN) gateway 110 which serves as a gateway that provides access between the EPC network 105 and various data networks, e.g., service network 140, IMS core network 115, other network(s) 180, and the like. The packet data network gateway is also referred to as a PDN gateway, a PDN GW or a PGW. In addition, the EPC network 105 may include a Diameter routing agent (DRA) 106, which may be engaged in the proper routing of messages between other elements within EPC network 105, and with other components of the system 100, such as a call session control function (CSCF) (not shown) in IMS core network 115. For clarity, the connections between DRA 106 and other components of EPC network 105 are omitted from the illustration of FIG. 1.

In one example, service network 140 may comprise one or more devices, such as application server (AS) 145 for providing services to subscribers, customers, and or users. For example, telecommunication service provider network 170 may provide a cloud storage service, web server hosting, social media applications, and other services. As such, service network 140 may represent aspects of telecommunication service provider network 170 where infrastructure for supporting such services may be deployed. Although a single application server, AS 145, is illustrated in service network 140, it should be understood that service network 140 may include any number of components to support one or more services that may be provided to one or more subscribers, customers, or users by the telecommunication service provider network 170.

In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general.

In accordance with the present disclosure, any one or more of the components of EPC network 105 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 107 may comprise a vMME, SGW 108 may comprise a vSGW, and so forth. In this regard, the EPC network 105 may be expanded (or contracted) to include more or less components than the state of EPC network 105 that is illustrated in FIG. 1. In this regard, the EPC network 105 may also include a self-optimizing network (SON)/software defined network (SDN) controller 190. In one example, SON/SDN controller 190 may function as a self-optimizing network (SON) orchestrator that is responsible for activating and deactivating, allocating and deallocating, and otherwise managing a variety of network components. For instance, SON/SDN controller 190 may activate and deactivate antennas/remote radio heads of cell sites 111 and 112, respectively, may allocate and deactivate baseband units in BBU pool 114, and may perform other operations for activating antennas based upon a location and a movement of a group of mobile endpoint devices, in accordance with the present disclosure.

In one example, SON/SDN controller 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

In accordance with the present disclosure, SON/SDN controller 190 may therefore control various components within EPC network 105 and/or within access network 103 to support the traffic that is accommodated by the activation of antennas/remote radio heads of cell sites 111 and 112, respectively and the allocation of baseband units in BBU pool 114. For instance, SON/SDN controller 190 (e.g., performing functions of a SON orchestrator) may activate an antenna of cell site 111 and assign a baseband unit in BBU pool 114 when a group of mobile endpoint devices is detected near the cell site 111. SON/SDN controller 190 (e.g., performing functions of a SDN controller) may further instantiate VNFs to function as routers, switches, gateways, and the like to ensure that sufficient backhaul resources are available for the traffic to transit the access network 103 and/or EPC network 105. In addition, as mentioned above, any one or more of the DRA 106, MME 107, SGW 108, HSS 109, and PGW 110 may comprise VNFs instantiated on host devices.

The SON/SDN controller 190 may be connected directly or indirectly to any one or more network elements of EPC network 105, and of the system 100 in general. Due to the relatively large number of connections available between SON/SDN controller 190 and other network elements, none of the actual links to the application server are shown in FIG. 1. Similarly, intermediate devices and links between DRA 106, MME 107, SGW 108, eNodeBs 111 and 112, PDN gateway 110, and other components of system 100 are also omitted for clarity, such as additional routers, switches, gateways, and the like.

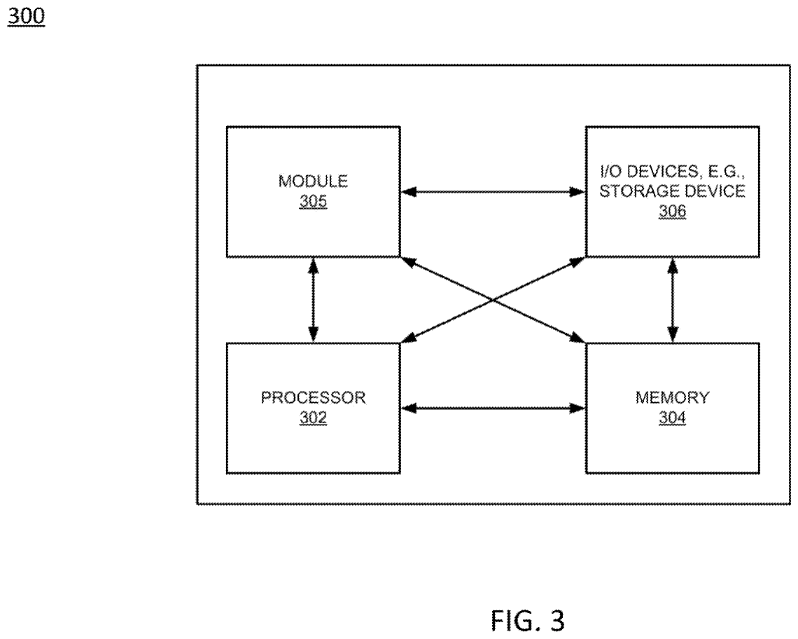

As further illustrated in FIG. 1, EPC network 105 may further include an application server (AS) 130 (e.g., serving as a security server), which may comprise all or a portion of a computing device or system, such as computing system 300, and/or processing system 302 as described in connection with FIG. 3 below, and may be configured to perform various operations in connection with detecting security anomalies in Internet of Things devices connected to the access network 103, and for performing various other operations in accordance with the present disclosure. For instance, AS 130 may host one or more applications that are configured to aggregate and model data RAN control plane signaling messages associated with IoT devices 116 and 117, for example, to construct baseline behavioral models for the IoT devices 116 and 117. In this regard, AS 130 may maintain communications with one or more sources that can intercept and collect these RAN control plane signaling messages.

One of these sources may comprise a database (DB) 185 in the EPC network 105, which may be in communication with the MME to store information extracted from RAN control plane signaling messages. The information stored in the database may include information about incoming and outgoing network traffic associated with various IoT devices, including IoT devices 116 and 117. For instance, the information may include numbers of incoming and outgoing data packets, sizes of payloads associated with incoming and outgoing data packets, frequencies of incoming and outgoing data packets, identities of devices to or from which the data packets were addressed, and locations of the IoT devices 116 and 117.

In one example, the DB 185 may also store data that associates TACs and/or IMEIs with specific IoT devices, including the IoT devices 116 and 117. Some of this device information may be retrieved from other data sources, such as a GSMA TAC database or similar data source.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN), EMSs, and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For instance, in one example, SON/SDN controller 190 may be spilt into separate components to operate as a SON orchestrator and a SDN controller, respectively. Similarly, although the SON/SDN controller 190 is illustrated as a component of EPC network 105, in another example SON/SDN controller 190, and/or other network components may be deployed in an IMS core network 115 instead of being deployed within the EPC network 105, or in other portions of system 100 that are not shown, while providing essentially the same functionality. Similarly, functions described herein with respect to AS 130 may alternatively or additionally be provided by AS 145.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer- readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In addition, although aspects of the present disclosure have been discussed above in the context of a long term evolution (LTE)-based wireless network, examples of the present disclosure are not so limited. Thus, the teachings of the present disclosure can be applied to other types of wireless networks (e.g., a 2G network, a 3G network, a 5G network, an integrated network, e.g., including any two or more of 2G-5G infrastructure and technologies, and the like), that are suitable for use in connection with examples of the present disclosure for detecting security anomalies in Internet of Things devices connected to a radio access network. For example, as illustrated in FIG. 1, the cellular network 101 may represent a “non-stand alone” (NSA) mode architecture where 5G radio access network components, such as a “new radio” (NR), “gNodeB” (or “gNB”), and so forth are supported by a 4G/LTE core network (e.g., a Evolved Packet Core (EPC) network 105). However, in another example, system 100 may instead comprise a 5G “standalone” (SA) mode point-to-point or service-based architecture where components and functions of EPC network 105 are replaced by a 5G core network, which may include an access and mobility management function (AMF), a user plane function (UPF), a session management function (SMF), a policy control function (PCF), a unified data management function (UDM), an authentication server function (AUSF), an application function (AF), a network repository function (NRF), and so on. For instance, in such a network, application server (AS) 130 of FIG. 1 may represent an application function (AF) for detecting security anomalies in Internet of Things devices connected to the access network 130 in accordance with various examples of the present disclosure. In addition, any one or more of cell sites 111-113 may comprise 2G, 3G, 4G and/or LTE radios, e.g., in addition to 5G new radio (NR) functionality. For instance, in non-standalone (NSA) mode architecture, LTE radio equipment may continue to be used for cell signaling and management communications, while user data may rely upon a 5G new radio (NR), including millimeter wave communications, for example. Thus, these and other modifications are all contemplated within the scope of the present disclosure.

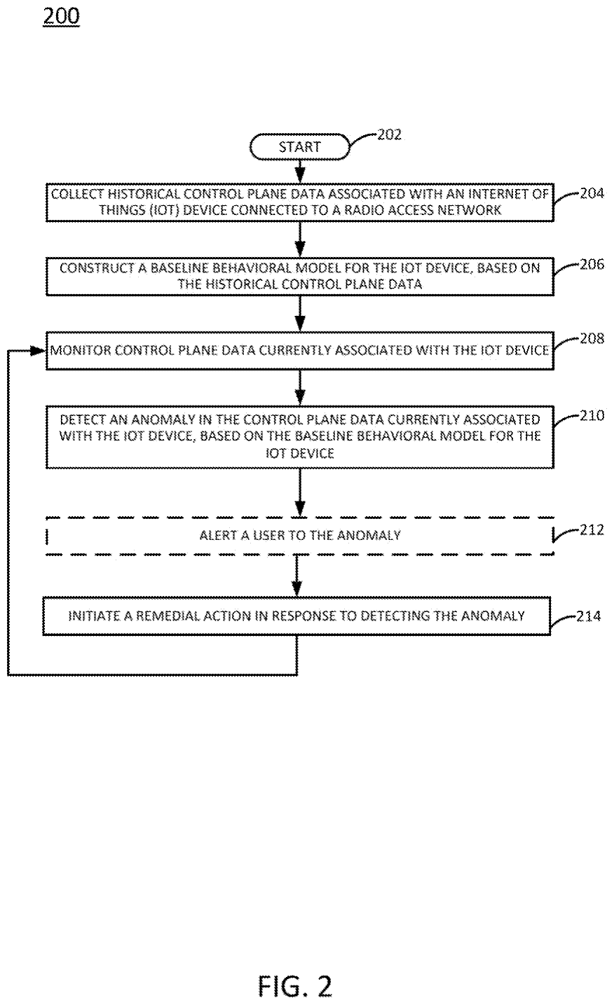

FIG. 2 illustrates a flowchart of an example method 200 for detecting security anomalies in Internet of Things devices connected to a radio access network, in accordance with the present disclosure. In one example, steps, functions and/or operations of the method 200 may be performed by a device as illustrated in FIG. 1, e.g., security server 130. In one example, the steps, functions, or operations of method 200 may be performed by a computing device or system 300, and/or a processing system 302 as described in connection with FIG. 3 below. For instance, the computing device 300 may represent at least a portion of the security server 130 in accordance with the present disclosure. For illustrative purposes, the method 200 is described in greater detail below in connection with an example performed by a processing system, such as processing system 302.

The method 200 begins in step 202 and proceeds to step 204. In step 204, the processing system may collect historical control plane data associated with an Internet of Things (IoT) device connected to a radio access network. As discussed above, in one example, the radio access network is part of a 3^{rd} generation (3G), 4^{th} generation (4G), 5^{th} generation (5G), or a higher or next generation wireless/cellular network. Thus, the historical control plane data associated with data packets originating and/or terminating at the IoT device may include call control (CC) and mobility management (MM) signaling messages. In one example, the historical control plane data may be collected from the eNodeB and/or the MME of the radio access network.

In one example, historical control plane data associated with the IoT device may be identified based on a unique identifier for the IoT device. For instance, the Global System for Mobile Communications (GSMA) allocates eight-digit numbers, known as type allocation codes (TACs), to 3^{rd} Generation Partnership Project (3GPP) device manufacturers. A TAC identifies a device's make and model; thus, different device models require different TACs. A TAC may be assigned at the device level or at the wireless module level. A wireless module may be used in many different devices (in which case the TAC may not be unique for a specific device, but rather for a set of devices).

The device manufacturers, in turn, may use the TACs to create unique, fifteen-digit device identifiers known as International Mobile Station Equipment Identities (IMEIs). A device's IMEI is embedded in the device at the time of manufacture and cannot be modified post-manufacture. A device with an improper or fraudulent NEI may be banned from networks and/or from distribution by government authorities.

Currently, the GSMA and its reporting bodies are one of the only globally recognized and official sources of TACs. Thus, the GSMA TAC database may be considered a reliable source of TAC data. A subset of the TACs generated by the GSMA may be approved for use on a particular RAN. As such, a cellular connected IoT device can be uniquely identified, and the RAN control plane events associated with the IOT device can be identified for further analysis. In some examples of the disclosure, RAN control plane events can also be analyzed at the TAC level (if one is interested in the behavior of a set of similar devices).

Thus, within the context of step 204, the IoT device may be a specific, individual device, or the IoT device may be representative of a group of devices of the same make and model (e.g., defined at the TAC level). Thus, the baseline behavioral model may be defined for a specific, individual device or for a group of devices of the same make and model.

In step 206, the processing system may construct a baseline behavioral model for the IoT device, based on the historical control plane data. In one example, the baseline behavioral model may be broken down into a plurality of windows of time. For instance, the baseline behavioral model may include twenty-four hour-long windows of time (e.g., 12:00 AM-1:00 AM; 1:00 AM-2:00 AM; . . . ; 11:00 PM-12:00 AM) for each day of the week (i.e., Sunday-Saturday). However, in other examples, the windows of time may be longer or shorter than one hour. Furthermore, the windows of time may not all have the same duration. For instance, if there is less control plane activity associated with the IoT device at certain times, then the windows of time during these times may be longer. As an example, if the IoT device is a virtual assistant device in a user's home, and the user is typically out of the home (e.g., at work) between the hours of 8:30 AM and 5:30 PM Monday through Friday, then the virtual assistant device may not send or receive many data packets during this time. As such, the windows of time defined between the hours of 8:30 AM and 5:30 PM Monday through Friday may be relatively long (e.g., two hours long or longer). However, during the times that the user is home and awake and likely to be using the virtual assistant device (e.g., 5:30 PM to 11:00 PM Monday through Friday; 8:00 AM to 11:00 PM Saturday; 8:00 AM to 11:00 PM Sunday), the windows of time may be relatively short (e.g., one hour or shorter).

In one example, the baseline behavioral model may further define a measure of the historical control plane data, such as the volume of historical control plane data that was observed to/is expected to traverse the IoT device during each window of time. In one example, the historical control plane data may comprise call control and/or mobility management signaling messages associated with data packets traversing the IoT device (i.e., data packets for which the IoT device is either the source or the destination). The volume of historical control plane data may be defined as an average number of signaling messages (e.g., x messages) or a range of numbers of signaling messages (e.g., x to y messages) that were observed to traverse the IoT device during the time window in the historical control plane data collected in step 204.

In another example, the baseline behavioral model may further define the sizes of the data packets that were observed to/are expected to traverse the IoT device during each window of time. The sizes of the data packets may be defined as an average packet payload size (e.g., x kilobytes) or a range of packet payload sizes (e.g., x to y kilobytes) that were observed to traverse the IoT device during the time window in the historical control plane data collected in step 204. In a further example, the baseline behavioral model may further differentiate between the directions of the packets when considering the sizes (e.g., large packets sizes may be typical for mobile terminated traffic, but not for mobile originated traffic, during the window of time).

In another example, the baseline behavioral model may define a frequency of signaling messages traversing the IoT device (e.g., number of inbound or outbound signaling messages per unit of time). Frequency of inbound or outbound signaling messages may be detected in one example from radio resource control (RRC) and/or cellular context (CTX) release events.

In another example, the baseline behavioral model may define a location of the IoT device for a window of time. For instance, if the IoT device is part of a connected car, the car may travel the same route when the user commutes to work on weekday mornings (e.g., 8:00 AM-8:30 AM) and to home on weekday evenings (e.g., 5:30 PM-6:00 PM). The car may sit in the parking lot of the user's place of employment during the time in between, and may sit in the user's garage or driveway overnight (e.g., 9:00 PM-8:00 AM). RAN events (e.g., the IoT device “pinging” a particular base station) may help to detect device location in one example.

In another example, the baseline behavioral model may define one or more access point names (APNs) that the IoT device is observed to connect to during a window of time. For instance, the IoT device may typically connect to the same gateway (having the same APN) during the same window or windows of time.

In one example, the baseline behavioral model may be constructed using manual (e.g., human-driven) techniques, machine learning techniques, and/or artificial intelligence techniques that can aggregate the collected historical control plane data and extract patterns from the aggregated control plane data.

In step 208, the processing system may monitor control plane data currently associated with the IoT device. For instance, the processing system may monitor a volume of signaling messages (e.g., call control and/or mobility management signaling messages) currently traversing the IoT device, a frequency of signaling messages currently traversing the IoT device, the sizes of packet payloads currently traversing the IoT device, and/or the current location or movements of the IoT device. In one example, the processing system may analyze each signaling message traversing the IoT device to extract one or more of these types of information.

In step 210, the processing system may detect an anomaly in the control plane data currently associated with the IoT device, based on the baseline behavioral model for the IoT device.

In one example, the signaling messages that are observed for the purposes of detecting the anomaly may be signaling messages associated with outbound (e.g., mobile originating) traffic, or data packets for which the IoT device is the source. In one particular example, an anomaly may be defined as any volume of control plane data (e.g., signaling messages) that is more than a threshold above a baseline volume of control plane data for a current window of time. For instance, the current window of time may be a Monday, between 4:00 PM and 5:00 PM, and the current volume of control plane data for the IoT device during the time window may be n signaling messages. The baseline value for the window of time may be j signaling messages (e.g., where j is an average number of signaling messages for the IOT device during the window of time), or j-k signaling messages (e.g., where j-k is range for an acceptable number of signaling messages for the IOT device during the window of time). If n exceeds j by more than a threshold (where j is the average number), or if n is more than a threshold below j or more than a threshold above k (where j-k defines a range), then the observation of n signaling messages during the window of time may be considered an anomaly.

In another example, if the frequency with which data packets are sent by the IoT device (e.g., number of packets sent per unit of time, such as packets per second) is greater than or less than a baseline frequency (for a window of time) by more than a threshold, this may constitute an anomalous activity that could be a sign of a denial of service (DOS) or other types of attack. The frequency of sent packets may be detected from radio resource control (RRC) and/or cellular context (CTX) release events.

In another example, if the sizes of the data packets that are sent by the IoT device (e.g., in bytes or kilobytes) are greater than or less that a baseline packet size (for a window of time) by more than a threshold, this may constitute anomalous activity that could be a sign of a denial of service (DOS) attack, a port sweep, or another type of compromise.

In another example, the signaling messages that are observed for the purposes of detecting the anomaly may be signaling messages associated with inbound (e.g., mobile terminated) traffic, or data packets for which the IoT device is the destination. For instance, if the frequency with which data packets are received by the IoT device (e.g., number of packets received per unit of time, such as packets per second) is greater than or less than a baseline frequency (for a window of time) by more than a threshold, this may constitute an anomalous activity that could be a sign of a denial of service (DOS) of other types of attack. The frequency of received packets may be detected from radio resource control (RRC) and/or cellular context (CTX) release events.

In another example, if the sizes of the data packets that are received by the IoT device (e.g., in bytes or kilobytes) are greater than or less that a baseline packet size (for a window of time) by more than a threshold, this may constitute anomalous activity that could be a sign of a denial of service (DOS) attack, a port sweep, or another type of compromise.

In another example, if the location of the IoT device is outside of some predefined radius (or threshold distance from a specific geographic location) for a window of time, this may constitute anomalous activity that could be a sign of theft or spoofing. For instance, if the IoT device is part of a connected car which normally sits in the parking lot of the user's place of employment between 8:30 AM and 5:30 PM on Mondays, but during that window of time the car is detected to be more than fifty miles from the user's place of employment, this may constitute an anomalous activity. Similarly, if an IoT device that is normally stationary (e.g., a virtual assistant device in a user's home) is detected to be moving or to have been moved to a different location, this may also constitute an anomalous activity.

In another example, if IoT device is exchanging data packets with another device with which the IoT device does not normally exchange data packets during a time window, this may constitute an anomalous activity that could be a sign of theft, spoofing, or a DOS attack. The other device's IP address may be identified as an IP address that the IoT device has not previously communicated with, or does not typically communicate with during a window of time.

In one example, an anomaly may be detected based on an anomalous combination of observations. For instance, if the baseline behavioral model indicates that, during the window of time, outbound packets from the IoT device tend to be relatively small in size (i.e., small payload) and infrequent, but the observed activity of the IoT device involves frequent outbound packets that are relatively large in size, an anomaly may be detected. Using a combination of observations (e.g., payload size and signaling message frequency, or another combination) to detect an anomaly, rather than relying on a single observation (e.g., just packet payload size, just signaling message frequency, etc.) may help to reduce the occurrence of false positives. For instance, relying only on the location of the IoT device may result in an anomaly being detected when a user takes his connected car on vacation (e.g., the user may drive the car outside of the baseline geographic radius during a time when he would normally be at work); however, the anomaly may not be a sign of a compromise. Thus, other observations (such as signaling message frequency, payload size, etc.) may not deviate from the baseline during this same window of time.

In optional step 212 (illustrated in phantom), the processing system may alert a user to the anomaly. For instance, if the IoT device is a home automation device in a user's home, then the user may be a home owner. If the IoT device is a manufacturing automation device in an industrial plant, then the user may be a human operator responsible for managing the plant's machinery. In one example, the alert may notify a user device (e.g., smart phone, tablet, laptop, etc.) of the user that an anomalous activity for the IoT device has been detected. The alert may, for instance, specify a volume of control plane data that was observed to traverse the IoT device, as well as an amount by which the volume of control plane data deviates from a baseline for the IoT device.

In one example, the alert may include a request for the user's permission to initiate a remedial action. For instance, if the control plane data currently associated with the IoT device is determined to be anomalous, which may potentially indicate a compromise of the IoT device, then the processing system may suggest blocking all network traffic to and/or from the IoT device (at least temporarily). In another example, however, the remedial action may comprise installing a software update (e.g., patch) on the IoT device. In another example, the remedial action may comprise scheduling maintenance of the IoT device (e.g., by a remote or in-person human technician or by a computer-operated diagnostic process) and/or changing an existing maintenance schedule for the IoT device (e.g., scheduling more or less frequent maintenance, moving up a scheduled maintenance task, etc.). In another example, the remedial action may comprise sending a signal to the IoT device instructing the IoT device to power down or to take some other actions (e.g., enter a “sleep” or “standby” mode, execute a diagnostic application, etc.). In a 5G network, the remedial action may include assigning the IoT device to a different slice of the network. Again, manual (e.g., human-driven) techniques, machine learning techniques, and/or artificial intelligence techniques may be used to determine the most appropriate remedial action based on the nature of the anomaly that is detected.

In step 214, the processing system may initiate a remedial action in response to detecting the anomaly. In one example, the processing system may wait for the user's permission before initiating the remedial action. The remedial action may be any of the remedial actions discussed above in connection with step 212, or may be another remedial action.

The method 200 may then return to step 208 and may continue to monitor control plane data currently associated with the IoT device as discussed above, generating alerts and/or initiating remedial actions when necessary. Continued monitoring of the IoT device may also serve to update or supplement the baseline behavioral model for the IoT device.

The method 200 is therefore able to detect anomalous behavior in an IoT device, which may be indicative of a compromise of the IoT device, and to take action to remediate the anomalous behavior if necessary. Moreover, because the method 200 relies on analysis of control plane data, as opposed to user plane data, the method 200 is less intrusive than conventional techniques which may expose sensitive user data. In one example, the method 200 may be implemented on the network operator side as a service that can be provided to customers. The network operator in this case would have ready visibility into the control plane data, as well as the necessary access to take certain types of remedial actions. The method 200 would allow the network operator to protect network resources and customer devices in a manner that respects customer data privacy.

Although the method 200 is described within the context of constructing a baseline behavioral model for a specific device, the techniques described above could be extrapolated to construct (and perform anomaly detection using) a baseline behavioral model for a group of devices in one embodiment. The group of devices may be defined at any level. For instance, the group of devices could be a set of the same type of devices (e.g., connected vehicle head units). In another example, the group of devices could be a set of the same make and/or model of devices (e.g., Brand X connected vehicle head units). In another example, the group of devices could be a set of the same make and/or model of devices used in the same context (e.g., Brand X connected vehicle head units deployed in Brand Y vehicles). Similar types of devices, and particularly similar makes and model of devices deployed in similar contexts, may exhibit similar baseline behaviors. Thus, in one example, if a baseline behavioral model is not available for a specific IoT device, a stored baseline behavioral model for a similar IoT device may be utilized instead, or at least until enough data about the specific IoT device can be collected for analysis.

The method 200 describes some examples of IoT device behaviors that may serve as the basis for detecting anomalous behaviors. For instance, as discussed above, anomalies could be detected based on the volume of incoming and/or outgoing data packets, the frequency of incoming and/or outgoing data packets, the payload sizes of incoming/outgoing data packets, the location of the IoT device, and the identities of the other devices with which the IoT device communicates.

In further examples, however, a baseline behavioral model for an IoT could be based on other types of device behaviors. For instance, an anomaly could be detected based on authentication request cause codes. A table that records device-based home location register (HLR)/home subscribe server (HSS) reject causes and reasons might allow the processing system to infer how often an IoT device has attempted to authenticate against the HLR/HSS, what the results of the authentication attempts were, and when the authentications attempts were rejected, the reasons for the rejections. If the processing system detects a number of rejected authentication attempts that exceeds some baseline number of rejected authentication attempts by more than a threshold, this could indicate a possible instance of device compromise (e.g., a fraudulent attempt to authenticate the device).

Building on the ability to detect failed authentication attempts, examples of the present disclosure could be used to minimize the allocation of resources to incorrectly programmed devices. For instance, a problem that is often encountered with IoT devices is that if an IoT device is incorrectly programmed, the IoT device may fail even before the IoT device can be authenticated to a base station. Since the IoT device never authenticates, the radio access network can never identify the IoT device. If a large enough number of IoT devices fail in this manner, the mass failure may result in resources being uselessly diverted from properly functioning user endpoint devices and may even block the base station (e.g., in a manner similar to a denial of service attack). However, if the processing system has access to data that can provide the system architecture evolution (SAE)-temporary mobile subscriber identities (S-TMSIs) of the incorrectly programmed IoT devices, the processing system may be able to correlate the S-TMSIs with the IoT devices that last attempted to authenticate. This could help the processing system to detect incorrectly programmed IoT devices and shut the IoT devices down sooner.

The method 200 describes several examples of control plane data that could be used to build a baseline behavioral model for anomaly detection. However, it will be appreciated that the control plane data elements described above do not comprise an exhaustive list. For instance, in further examples, other control plane data elements could be used. Additionally, the manner of obtaining the control plane data elements may differ depending on the make and model of the IoT device.

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the methods can be stored, displayed, and/or outputted either on the device executing the methods or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described methods can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for detecting security anomalies in Internet of Things devices connected to a radio access network, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above are implemented in a distributed or parallel manner for a particular illustrative example, i.e., the steps of the above method 200 or the entire method 200 are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for detecting security anomalies in Internet of Things devices connected to a radio access network (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for detecting security anomalies in Internet of Things devices connected to a radio access network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
collecting, by a processing system including at least one processor, historical control plane data associated with an internet of things device connected to a radio access network;
constructing, by the processing system, a baseline behavioral model for the internet of things device, based on the historical control plane data;
monitoring, by the processing system, control plane data currently associated with the internet of things device;
detecting, by the processing system, an anomaly in the control plane data currently associated with the internet of things device, based on the baseline behavioral model for the internet of things device; and
initiating, by the processing system, a remedial action in response to the detecting.

2. The method of claim 1, wherein the historical control plane data comprises at least one selected from a group of: call control signaling messages associated with the internet of things device and mobility management signaling messages associated with the internet of things device.

3. The method of claim 2, wherein the call control signaling messages and the mobility management signaling messages are identified based on an international mobile station equipment identity for the internet of things device.

4. The method of claim 1, wherein the baseline behavioral model comprises:
a plurality of windows of time; and
for each window of time of the plurality of windows of time, a measure of the historical control plane data associated with the each window.

5. The method of claim 4, wherein the measure of the historical control plane data comprises a volume of the historical control plane data that was outbound from the internet of things device during the each window of time, and wherein the detecting comprises:
determining, by the processing system, that a volume of the control plane data currently associated with the internet things device that is outbound from the internet things device deviates from the volume of the historical control plane data by more than a threshold.

6. The method of claim 4, wherein the measure of the historical control plane data comprises a volume of the historical control plane data that was inbound to the internet of things device during the each window of time, and wherein the detecting comprises:
determining, by the processing system, that a volume of the control plane data currently associated with the internet things device that is inbound to the internet things device deviates from the volume of the historical control plane data by more than a threshold.

7. The method of claim 4, wherein the measure of the historical control plane data comprises a frequency of the historical control plane data that was outbound from the internet of things device during the each window of time, and wherein the detecting comprises:
determining, by the processing system, that a frequency of the control plane data currently associated with the internet things device that is outbound from the internet things device deviates from the frequency of the historical control plane data by more than a threshold.

8. The method of claim 4, wherein the measure of the historical control plane data comprises a frequency of the historical control plane data that was inbound to the internet of things device during the each window of time, and wherein the detecting comprises:
determining, by the processing system, that a frequency of the control plane data currently associated with the internet things device that is inbound to the internet things device deviates from the frequency of the historical control plane data by more than a threshold.

9. The method of claim 4, wherein the measure of the historical control plane data comprises a size of a payload of a data packet contained in the historical control plane data that was outbound from the internet of things device during the each window of time, and wherein the detecting comprises:
determining, by the processing system, that a size of a payload of a data packet of the control plane data currently associated with the internet things device that is outbound from the internet things device deviates from the size of the payload of the data packet contained in the historical control plane data by more than a threshold.

10. The method of claim 4, wherein the measure of the historical control plane data comprises a size of a payload of a data packet contained in the historical control plane data that was inbound to the internet of things device during the each window of time, and wherein the detecting comprises:
determining, by the processing system, that a size of a payload of a data packet of the control plane data currently associated with the internet things device that is inbound to the internet things device deviates from the size of the payload of the data packet contained in the historical control plane data by more than a threshold.

11. The method of claim 4, wherein the measure of the historical control plane data comprises a location of the internet of things device during the each window of time, and wherein the detecting comprises:
determining, by the processing system, that a location of the internet of things device indicated in the control plane data currently associated with the internet things device is outside of a threshold radius from the location of the internet of things device during the each window of time.

12. The method of claim 11, wherein the location of the internet of things device during the each window of time comprises a base station of the radio access network with which the internet of things device communicated during the each window of time.

13. The method of claim 4, wherein the measure of the historical control plane data comprises an access point name of a gateway to which the internet of things device connected during the each window of time.

14. The method of claim 1, wherein the remedial action comprises blocking all traffic of the radio access network to and from the internet of things device.

15. The method of claim 1, wherein the remedial action comprises at least one selected from a group of: instructing the internet of things device to power down and installing a software update on the internet of things device.

16. The method of claim 1, wherein the remedial action comprises changing a maintenance schedule of the internet of things device.

17. The method of claim 1, wherein the remedial action comprises moving the internet of things device to a new slice of a telecommunications service provider network including the radio access network.

18. The method of claim 1, wherein the baseline behavioral model is constructed for a set of internet of things devices including the internet of things device, wherein all devices in the set of internet of things devices share at least one of: a common type allocation code and a common international mobile station equipment identity.

19. A non-transitory computer-readable medium storing instructions which, when executed by a processing system including at least one processor, cause the processing system to perform operations, the operations comprising:
collecting historical control plane data associated with an internet of things device connected to a radio access network;
constructing a baseline behavioral model for the internet of things device, based on the historical control plane data;
monitoring control plane data currently associated with the internet of things device;
detecting an anomaly in the control plane data currently associated with the internet of things device, based on the baseline behavioral model for the internet of things device; and
initiating a remedial action in response to the detecting.

20. A device comprising:
a processing system including at least one processor; and
a non-transitory computer-readable medium storing instructions which, when executed by the processing system, cause the processing system to perform operations, the operations comprising:
collecting historical control plane data associated with an internet of things device connected to a radio access network;
constructing a baseline behavioral model for the internet of things device, based on the historical control plane data;
monitoring control plane data currently associated with the internet of things device;
detecting an anomaly in the control plane data currently associated with the internet of things device, based on the baseline behavioral model for the internet of things device; and
initiating a remedial action in response to the detecting.
